(19) United States
(12) Patent Application Publication
(10) Pub. No.: US 2009/0064925 A1
(43) Pub. Date: Mar. 12, 2009

(54) APPARATUS FOR CONTROLLING THE ADHESIVE FEED TO AN APPLICATION COMB

(75) Inventor: Jorg OBENAUER, Weenzen (DE)

Correspondence Address: FOX ROTHSCHILD LLP, 2000 MARKET STREET, 10th Floor, PHILADELPHIA, PA, 19103, US

(73) Assignee: GreCon Dimter Holzoptimierung Nord GmbH & Co. KG, Alfeld (DE)

(21) Appl. No.: 12/207,838

(22) Filed: Sep. 10, 2008

(30) Foreign Application Priority Data
Sep. 11, 2007 (DE) 202007012714.6

(51) Int. Cl. B05C 1/00

(52) U.S. Cl. 118/242

(57) ABSTRACT

The line (4) intended for applying glue to a workpiece having a finger-jointing profile at the end face and supplying glue to an application comb (1) to be operated in accordance with the working cycle of a finger-jointing plant forms, via a branching point (5), a through-connection with two supply branches which are identical to one another and each of which consists of a metering cylinder (8, 9), connected to a feed line (12, 13) for glue, and of a pneumatically controllable control cylinder (10, 11) which can be operated by a directional control valve (18, 19). The metering piston (8′, 9′) of each metering cylinder (8, 9) is connected via a piston rod (10″, 11″) to the control piston (10′, 11′) of the associated control cylinder (10, 11), such that the metering piston can be moved pneumatically between a first position, in which there is a through-connection between the feed line (12, 13) and the application comb, and a second position, in which this connection does not exist. By means of a primary control system, the two directional control valves (18, 19) are cyclically activated in succession in such a way that the application comb (1) is successively supplied with glue from the two supply branches via the branching point (5), such that the working cycle of a glue application can be doubled with unchanged operating frequency of the two directional control valves.

The invention relates to an apparatus according to the preamble of claim 1.

In the production of end joints between elongated, wooden beam-, rod- or also board-shaped workpieces by finger jointing, the workpiece end faces profiled in a finger-joint-like manner by routing must be covered with an adhesive film, as a rule a glue film, before the joint is produced by fitting together and pressing. In this way, in accordance with the number of workpieces thus joined, elongated structural elements, which can be used, for example, in furniture or window construction, of reproducible quality can be provided. DE 102 25 329 A1 discloses a finger-jointing plant which is intended for the production of structural elements fitted together on this basis and in which the workpieces to be treated are successively routed at the end face, covered with adhesive, fitted together and pressed in a quasi-continuous process.

Used for the transfer of glue to the routed end faces are, inter alia, application combs, in particular glue combs, which are provided with an internal line system via which the glue is conducted directly into the region of the comb profile and discharges here in order to be subsequently transferred to the workpiece profile by a wiping movement. Said comb profile is always dimensioned in such a way that it can be brought into engagement with the workpiece profile for the purpose of the adhesive transfer, such that a uniform adhesive film can be formed via the wiping movement.

The feeding of adhesive in a liquid state to the application comb and equally the discharge of the adhesive from the comb profile are effected discontinuously in accordance with the working cycle of the finger-jointing plant, thus as a function of the speed with which workpieces routed at the end face arrive in the area of action of the comb profile. This means that the valves used for the pneumatic control of the adhesive flow and acting on metering members have to be operated in accordance with an operating frequency corresponding to the working cycle of the finger-jointing plant. Such pneumatic control of the adhesive flow is known in the applicant's company.

However, in the course of generally increasing the output, here increasing the throughput, in finger-jointing plants, the problem arises that there are limits to increases in the operating frequency of said valves, e.g. directional control valves, also with regard to their wear and service life.

It is therefore the object of the invention to improve an apparatus of the type mentioned at the beginning, compared with the prior art described above, with a view to increasing the possible operating frequency. This object is achieved in such an apparatus by the features of the characterizing part of claim 1.

Accordingly, it is essential to the invention that at least two supply branches are set up upstream of the application comb, each of which can be pneumatically controlled cyclically between an open and a closed state and can be operated in such a way that their individual cycle times make up the working cycle of a finger-jointing plant. This means that an adhesive feed is effected in a metered manner and successively from at least two supply branches which are combined on the outlet side at a branching point. At a given working cycle of the finger-jointing plant, the operating frequency at which the supply branches have to be operated is therefore reduced in accordance with their number. This inventive type of pneumatic control of the adhesive feed to an application comb can therefore be adapted in virtually any desired manner to increasing working cycles of a finger-jointing plant, if need be by adding further supply branches to the circuit.

The features of claims 2 and 3 relate to a configuration of a supply branch. Accordingly, said supply branch is equipped with a metering cylinder and a feed line for liquid adhesive or glue. The metering cylinder forms a member which can be operated between a closed state, in which an adhesive discharge in the direction of the application comb is prevented, and an open state, in which an adhesive discharge in the direction of the application comb is released. Provided these functions have been fulfilled, another component may also be arranged at this point. Furthermore, each supply branch is equipped with a pneumatically operable control unit which is set up for operating the metering cylinder or the other component of identical function arranged at this point.

According to the features of claim 4, the control unit consists of a control cylinder, in which a control piston is arranged in a slidable manner, the movement of which is linked to that of the metering piston inside the metering cylinder.

By means of a primary electrical, mechanically adjustable or preferably freely programmable control system according to the features of claim 5, the control units of the at least two supply branches can be controlled in a coordinated manner with respect to time, to be precise with the aim of adaptation to the predetermined working cycle of the finger-jointing plant.

The features of claims 6 and 7 relate to the further configuration of a control unit. Accordingly, said control unit contains at least one directional control valve which is operatively connected to the preferably double-acting control cylinder, to be precise in conjunction with a pressure source, with the aim of setting a forward and a return stroke of the control piston in accordance with adjustable cycle times.

In accordance with the features of claim 8, the control piston is preferably coupled to the metering piston mechanically, e.g. via a piston rod. However, other types of coupling, e.g. electrical, are not ruled out.

The features of claim 9 relate to a simple possibility of connecting up the control cylinder. It is essential in this case that the forward and the return stroke are produced by means of one directional control valve, namely by its reversal.

The features of claims 10 and 11 relate to an alternative way of connecting up the control cylinder. Accordingly, a directional control valve is available both for the forward stroke and for the return stroke, as a result of which a further acceleration of the reversal of the movement of the control piston can be achieved. According to a further development of this solution approach, the activation times of the two directional control valves are established in such a way that slight overlaps, which can preferably be set, of the application of pressure to the control piston on both sides are obtained at the respective dead centres of the stroke movements. This provides a further possibility for configuring the sequence of movement of the control piston, in particular its acceleration.

The invention is explained in more detail below with reference to the exemplary embodiments reproduced schematically in the drawings, in which:

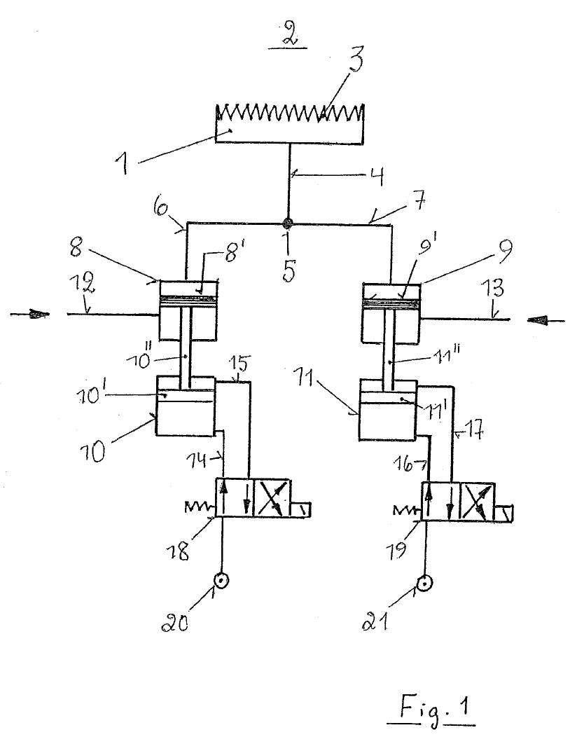

FIG. 1 shows a first exemplary embodiment of a circuit diagram according to the invention for the supply of adhesive to an application comb;

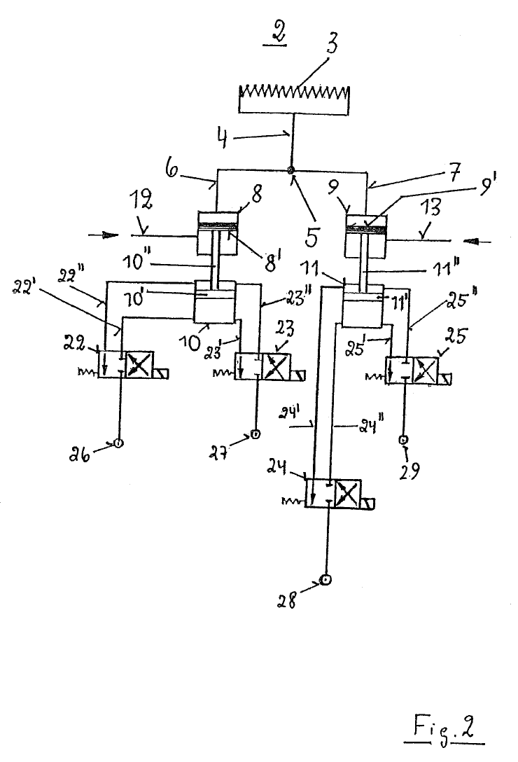

FIG. 2 shows a second exemplary embodiment of a circuit diagram according to the invention for the supply of adhesive to an application comb.

An application comb which is intended for use in a finger-jointing plant and has a finger-jointing profile 3 on its front side is designated by 1 in FIG. 1, said finger-jointing profile being intended for combing engagement with the correspondingly designed profile, to be covered with an adhesive film, of a workpiece.

The application comb 1 is connected to a line 4 which is intended for supplying adhesive on the inlet side and which, in a manner not shown in the drawing but known per se, ends in bores on the outlet side in the region of the finger-jointing profile 3 via distribution lines running inside the application comb 1. The adhesive discharging from these bores is intended to be transferred to the profile of the workpiece in a film-like manner by a wiping movement.

The line 4 ends at a branching point 5, to which a respective metering cylinder 8, 9 is attached via two branch lines 6, 7.

Designated by 10, 11 are respective control cylinders, the control pistons 10′, 11′ of which are fixedly connected via a respective piston rod 10″, 11″ to a metering piston 8′, 9′ arranged inside the respective metering cylinder 8, 9.

The movements of the metering pistons 8′, 9′ are therefore coupled with those of the control pistons 10′, 11′ via the piston rods 10″, 11″.

Each metering cylinder 8, 9 is connected via a feed line 12, 13 to a reservoir of liquid adhesive or glue, which is therefore fed under pressure to the respective metering cylinder 8. 9. Each of the two metering cylinders 8, 9 is designed to the effect that the metering piston is movable at least between two positions, namely a first position in which there is a through-connection between the respective feed line 12, 13 and the application comb 1 via the corresponding branch line 6, 7, and a second position in which this connection does not exist.

The control pistons 10′, 11′ are double-acting, and the control cylinders 10, 11 are each connected by two lines 14, 15 and 16, 17, respectively, to a respective directional control valve 18, 19 having two operating positions. The drawing shows, merely by way of example, directional control valves whose one operating position can be produced by spring force and whose other operating position can be produced electrically.

Designated by 20, 21 are respective compressed-air sources via which the control piston 10′, 11′ can be acted upon for a forward or a return stroke in accordance with the operating position of the two directional control valves 18, 19. The drawing according to FIG. 1 shows both directional control valves in the same operating position, in which the front side of the control piston 10′, 11′ is acted upon; the control piston therefore moves in the direction of the metering cylinder, whereas the rear side of the control piston is vented via the line 15, 17. In the other operating position, the rear side of the control piston 10′, 11′ is accordingly acted upon.

Not shown in the drawing is a control system by means of which the operating positions of the directional control valves 18, 19 are coordinated in timing with regard to the working cycle, predetermined by the finger-jointing plant, of the adhesive application. However, the basic construction of said control system is readily comprehensible to the person skilled in the art with reference to the present functional description, and therefore this is not dealt with below.

A freely programmable control system is preferably suitable; other types of control system, in particular mechanical activation, are however also possible.

The two subassemblies consisting in each case of a directional control valve 18, 19, a control cylinder 10, 11 and a metering cylinder 8, 9 form supply branches which are activated successively, such that there is an adhesive flow either from the feed line 12 or the feed line 13 in the direction of the application comb 1. That is to say, the directional control valves assume in practice such positions in which, as shown in the drawing, both metering cylinders 8, 9 are in the closed position or such combinations of positions in which the one metering cylinder is in the open position and the other respective metering cylinder is in the closed position.

When in use, the application comb 1 must be supplied with adhesive in accordance with a working cycle which is predetermined by the operation of the finger-jointing plant. Each working cycle requires opening and closing of a connection between the application comb 1 and an adhesive reservoir, such that a defined quantity of adhesive can flow in the time interval between the open and the closed state.

Owing to the fact that, according to the invention, two supply branches are provided which are activated one after the other, the operating frequency of the directional control valves can be halved during the same working cycle of the finger-jointing plant. Alternatively, within a limit determined by the maximum admissible operating frequency of the directional control valves, a working cycle of the finger-jointing plant can be operated which turns out to be higher than said operating frequency.

In FIG. 2, functional elements which correspond to those in FIG. 2 are correspondingly designated, such that a repeated description in this respect can be dispensed with.

In deviation from the exemplary embodiment according to FIG. 1, two directional control valves 22, 23 and 24, 25, respectively, which each have two operating positions, are now assigned to each control cylinder 10, 11. A compressed-air source 26, 27, 28, 29 is assigned to each of these directional control valves.

The control pistons 10′, 11′ of the two control cylinders 10, 11 are again double-acting, although a directional control valve 22, 23; 24, 25 is assigned to the forward stroke and the return stroke, respectively. Both directional control valves of a control cylinder are connected to the respective control cylinder 10, 11 via lines 22′, 22″; 23′, 23″; 24′, 24″ and 25′, 25″. All the directional control valves 22, 23, 24, 25 are again connected to a control system (not shown in the drawing) coordinating their operating positions in timing and in accordance with the working cycle of the finger-jointing plant.

The statements made above with respect to FIG. 1 equally apply to the structure of this control system.

The operating positions of the directional control valves of each control cylinder 10, 11, in particular their flow paths, are established to the effect that a directional control valve is assigned to each stroke, wherein the valve assigned to the other respective stroke can always be functionless or is operated for venting. Application of pressure to the control cylinder therefore always takes place only via one directional control valve. This is a first possibility for activating the directional control valves, which leads to a further increase in the frequency with which reversal of the two supply branches can be carried out.

Alternatively, the two directional control valves of a control cylinder 10, 11 can also be activated in such a way that a time overlap of the application of pressure to the control cylinders via both directional control valves is set up. Thus, for example when changing over from the forward stroke to the return stroke, the directional control valve set up for the return stroke can be activated before the directional control valve set up for the forward stroke is rendered inactive, and vice versa. The last-mentioned measure can also achieve improved adaptation of the cyclic supply of adhesive to the application comb 1 in accordance with the working cycle of the finger-jointing plant while using conventional directional control valves.

1. Apparatus for the pneumatic control of the feed of liquid adhesive to an application comb (1) intended for the quasi-continuous operation of a finger-jointing plant and transferring the adhesive in accordance with the working cycle of the finger-jointing plant to the workpieces to be joined, comprising means for the cyclic transfer of the adhesive, starting from at least one feed line (12, 13), into a line forming a through connection to the application comb (1), characterized by at least two supply branches which can be operated cyclically in accordance with an open state, in which an adhesive discharge is released in the direction of the application comb (1), and a closed state, in which an adhesive discharge is blocked, and the individual cycles of which make up the working cycle of the finger-jointing plant, each supply branch having an outlet line (6, 7), and all the outlet lines (6, 7) being attached to a branching point (5) connected to the line (4).

2. Apparatus according to claim 1, characterized in that each supply branch consists of a metering cylinder (8, 9) and a pneumatically operable control unit assigned to said metering cylinder (8, 9).

3. Apparatus according to claim 1 wherein, each said supply branch is equipped with a feed line (12, 13) for adhesive.

4. Apparatus according to claim 2 wherein each said control unit consists of a pneumatically operable control cylinder (10, 11), in which a control piston (10′, 11′) is arranged in a slidable manner, the movement of which is linked to that of a metering piston (8′, 9′) inside the metering cylinder (8, 9).

5. Apparatus according to claim 1 wherein each said supply branch is operatively connected to a primary electrical control system and is established independently in a controllable manner.

6. Apparatus according to claim 4 wherein each said control unit has at least one directional control valve (18, 19) which is operatively connected to the metering cylinder (10, 11).

7. Apparatus according to claim 4 wherein the control cylinder (10′, 11′) is double-acting.

8. Apparatus according to claim 4 wherein the control piston (10′, 11′) of the control cylinder (10, 11) is mechanically coupled to the metering piston (8′, 9′) of the metering cylinder (8, 9).

9. Apparatus according to claim 6 wherein the control cylinder (10, 11) is connected up in such a way that in each case the forward and the return stroke of the control piston (10′, 11′) can be initiated via one directional control valve (10, 11) in conjunction with a pressure source (20, 21).

10. Apparatus according to claim 6 wherein the control cylinder (10, 11) is connected up in such a way that a directional control valve (22, 23; 24, 25) in conjunction with a pressure source (26, 27, 28, 29) is provided for the forward stroke and the return stroke, respectively, of the control piston (10′, 11′).

11. Apparatus according to claim 10 wherein the activation times of the directional control valves (22, 23; 24, 25) of a supply branch are established in such a way that slight overlaps, which can be set with respect to time, of the application of pressure to the control piston (10′, 11′) on both sides are obtained at the respective dead centers of the stroke movements.

12. Apparatus according to claim 2 wherein each said supply branch is equipped with a feed line for adhesive.

13. Apparatus according to claim 12 wherein each said control unit consists of a pneumatically operable control cylinder, in which a control piston is arranged in a slidable manner, the movement of which is linked to that of a metering piston inside the metering cylinder.

14. Apparatus according to claim 2 wherein each said supply branch is operatively connected to a primary electrical control system and is established independently in a controllable manner.

15. Apparatus according to claim 3 wherein each said supply branch is operatively connected to a primary electrical control system and is established independently in a controllable manner.

16. Apparatus according to claim 4 wherein each said supply branch is operatively connected to a primary electrical control system and is established independently in a controllable manner.

17. Apparatus according to claim 16 wherein each said control unit has at least one directional control valve which is operatively connected to the metering cylinder.

18. Apparatus according to claim 16 wherein the control cylinder is double-acting.

19. Apparatus according to claim 6 wherein the control cylinder is double-acting.

20. Apparatus according to claim 16 wherein the control piston of the control cylinder is mechanically coupled to the metering piston of the metering cylinder.
